(19) United States
(12) Patent Application Publication
(10) Pub. No.: US 2006/0261981 A1
(43) Pub. Date: Nov. 23, 2006

(54) Vehicle locating unit proof of life subsystem and method

(76) Inventors: Frank Romano, Westborough, MA (US); Sampath Krishna, Winchester, MA (US); Son Nguyen, Marlborough, MA (US); Jesse Rhodes, Franklin, MA (US); Philip Grahame Crewe, Linton (GB); Daniel Jonathan Finchley Cletheroe, Cambridge (GB); Mark Marsden, Saffron Walden (GB); Steven Walter Greendale, Cambridge (GB); Nigel James Watson, Whittlesford (GB); Ian Christopher Stroud, Newport (GB); Timothy David Howe, Great Shelford (GB); Gerard Edward Smith, Great Dunmow (GB)

Correspondence Address: Iandiorio & Teska, 260 Bear Hill Road, Waltham, MA, 02451-1018, US

(21) Appl. No.: 11/131,848

(22) Filed: May 18, 2005

(51) Int. Cl. B60R 25/10

(52) U.S. Cl. 340/988; 340/428

(57) ABSTRACT

A vehicle locating unit features a receiver which receives a signal from a network of communication sources and a transponder activated when a communication source sends a message to the receiver. There is a transmitter for sending signals to the communication sources and a proof of life subsystem configured to periodically send a proof of life message via the transmitter to the communication sources.

### FIELD OF THE INVENTION

This invention relates to stolen vehicle recovery systems and in particular a vehicle locating unit proof of life messaging subsystem and method.

### BACKGROUND OF THE INVENTION

The applicant's successful and popular vehicle recovery system sold under the trademark LoJack® includes a small electronic vehicle locating unit (VLU) with a transponder hidden within a vehicle, a private network of communication towers each with a remote transmitting unit (RTU), one or more law enforcement vehicles equipped with a vehicle tracking unit (VTU), and a network center with a database of customers who have purchased a VLU. The network center interfaces with the National Criminal Information Center. The entries of that database comprise the VIN number of the customer's vehicle and an identification code assigned to the customer's VLU.

When a LoJack® product customer reports that her vehicle has been stolen, the VIN number of the vehicle is reported to a law enforcement center for entry into a database of stolen vehicles. The network center includes software that interfaces with the database of the law enforcement center to compare the VIN number of the stolen vehicle with the database of the network center which includes VIN numbers corresponding to VLU identification codes. When there is a match between a VIN number of a stolen vehicle and a VLU identification code, as would be the case when the stolen vehicle is equipped with a VLU, and when the center has acknowledged the vehicle has been stolen, the network center communicates with the RTUs of the various communication towers (currently there are 130 nationwide) and each tower transmits a message to activate the transponder of the particular VLU bearing the identification code.

The transponder of the VLU in the stolen vehicle is thus activated and begins transmitting the unique VLU identification code. The VTU of any law enforcement vehicles proximate the stolen vehicle receive this VLU transponder code and, based on signal strength and directional information, the appropriate law enforcement vehicle can take active steps to recover the stolen vehicle. See, for example, U.S. Pat. Nos. 4,177,466; 4,818,988; 4,908,609; 5,704,008; 5,917,423; 6,229,988; 6,522,698; and 6,665,613 all incorporated herein by this reference.

If, however, a component of the VLU fails, it may not receive messages from the communication towers of a network and/or may fail to transmit its unique VLU identification code for receipt by one or more vehicle tracking units.

Presently, vehicle locating units are not configured to transmit messages to the network communication towers. Thus, there is no present way of detecting if a VLU has failed in the field so it can be serviced.

### SUMMARY OF THE INVENTION

It is therefore an object of this invention to provide a vehicle locating unit with uplink capability.

It is a further object of this invention to provide such a vehicle locating unit which can be identified as failed and serviced when needed.

It is a further object of this invention to provide a method of servicing failed vehicle locating units in the field.

The subject invention results from the realization that if the vehicle locating unit is equipped with the transmitter for sending signals to the network or other communication sources, the vehicle locating unit itself can periodically send a “proof of life” message via the transmitter to the communication sources. If the appropriate message is not received as expected from a vehicle locating unit, that vehicle locating unit can be identified, located, and serviced as appropriate.

The subject invention, however, in other embodiments, need not achieve all these objectives and the claims hereof should not be limited to structures or methods capable of achieving these objectives.

This invention features a vehicle locating unit with proof of life functionality. A receiver receives a signal from a network of communication sources and a transponder is activated when a communication source sends a message to the receiver. A transmitter is included for sending signals to the communication sources, and a proof of life subsystem is configured to periodically send a proof of life message via the transmitter to the communication sources.

Typically, the proof of life message includes a unique vehicle locating unit identification code and the identification code of a communication source transmitting the strongest signal to the receiver to approximate the position of the vehicle. Preferably, a signal strength determining subsystem determines the communication source with the strongest signal transmitted to the receiver.

A method of servicing failed vehicle locating units in accordance with the subject invention includes the steps of configuring the vehicle locating unit to periodically send a message to one or more communication sources, logging said message in a database, and servicing the vehicle locating unit if said message is not received. Typically, the message includes a unique vehicle locating unit identification code and an identification code of a communication source transmitting the strongest signal to the vehicle locating unit to approximate the position of the vehicle locating unit. One method of operating a vehicle locating unit in accordance with the subject invention includes the steps of receiving signals from a network of communication sources, and activating a transponder when a communication source sends a message to vehicle locating unit. A proof of life message is periodically sent to the communication sources so the vehicle locating unit can be serviced when it is detected no proof of life message has been received as expected.

### BRIEF DESCRIPTION OF THE DRAWINGS

Other objects, features and advantages will occur to those skilled in the art from the following description of a preferred embodiment and the accompanying drawings, in which:

FIG. 1 is a schematic block diagram showing the primary components associated with an example of a stolen vehicle recovery system in accordance with the subject invention;

FIG. 2 is a block diagram showing the primary components associate with an embodiment of a vehicle locating unit in accordance with the subject invention; and

FIG. 3 is a block diagram depicting the primary steps associated with the programming of the microcontroller shown in FIG. 2 according to one embodiment of the subject invention.

### DISCLOSURE OF THE PREFERRED EMBODIMENT

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

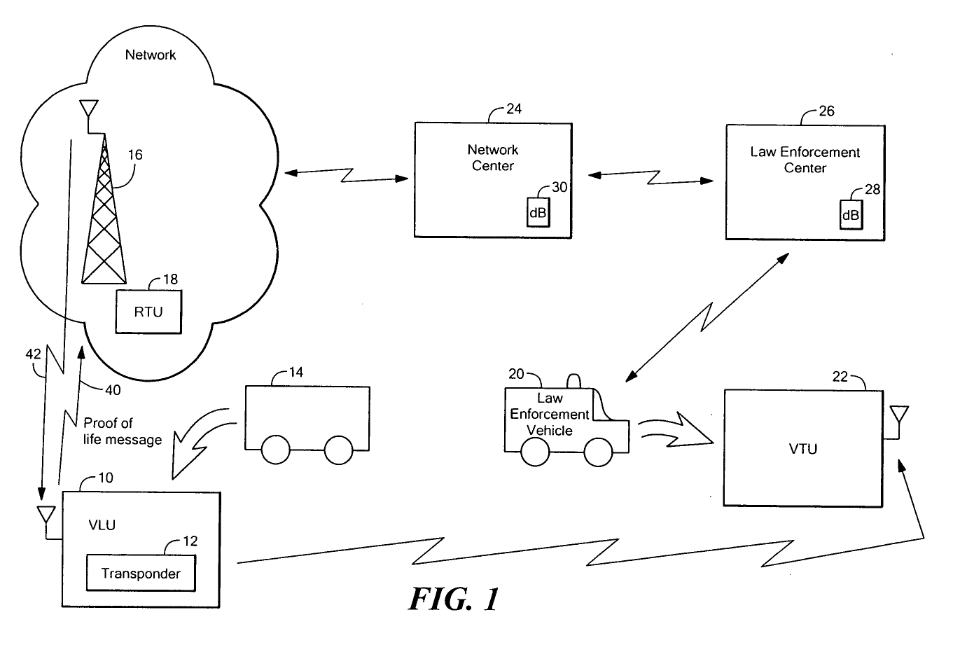

As discussed in the background section above, the applicant's successful and popular vehicle recovery system sold under the trademark LoJack® includes a small electronic vehicle locating unit (VLU) 10, FIG. 1 with a transponder 12 hidden within a vehicle 14, a private network of communication towers 16 each with a remote transmitting unit (RTU) 18, one or more law enforcement vehicles 20 equipped with a vehicle tracking unit (VTU) 22, and network center 24.

When a LoJack® product customer reports that her vehicle has been stolen, the VIN number of the vehicle is reported to law enforcement center 26 for entry into database 28 of stolen vehicles. Network center 24 includes software that interfaces with database 28 of law enforcement center 26 to compare the VIN number of the stolen vehicle with database 30 of network center 24 which includes VIN numbers corresponding to VLU identification codes. When there is a match between a VIN number of a stolen vehicle and a VLU identification code, as would be the case when stolen vehicle 14 is equipped with VLU 10, network center 24 communicates with the RTUs 18 of the various communication towers 16 and each tower transmits a message to activate transponder 12 of VLU 10 bearing the particular identification code.

Transponder 12 of VLU 10 in stolen vehicle 14, once activated, begins transmitting a unique VLU identification code. VTU 22 of law enforcement vehicle 20 proximate stolen vehicle 14 receives this VLU transponder code and, based on signal strength and directional information, the appropriate law enforcement vehicle can take active steps to recover stolen vehicle 14.

In accordance with the subject invention, VLU 10 is configured to periodically send a proof of life message as shown at 40 to a network communication tower 16 of the communication network in addition to receiving messages from network 42 in the case of a theft of vehicle 14 in which case transponder 12 is activated. The proof of life message 40 is periodically sent by VLU 10 and typically includes the identity of the VLU unit and the identification code of tower 16 having the greatest signal strength. This message is conveyed by RTU 18 to network center 24 and stored in database 30. Appropriate software at center 24 polls database 30 periodically and if any VLU unit is found not to have transmitted a proof of life message as expected, an alarm message can be generated and the customer's VLU can be serviced. By storing with the last proof of life message the identity of the tower most proximate vehicle 14, the approximate last known location of vehicle 14 can be determined in order to better service VLU 10.

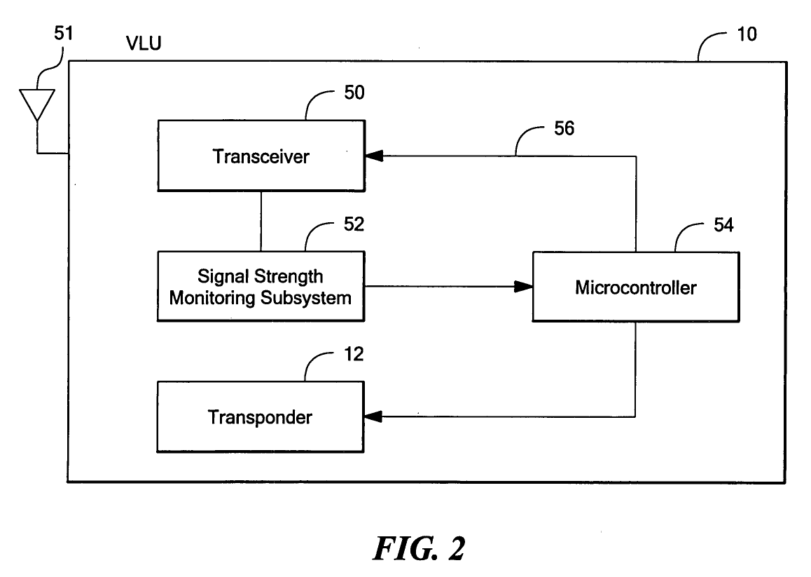

VLU 10, in one example, is shown in more detail in FIG. 2 where transceiver 50 includes both message reception and message transmission functionality. Any signal received by transceiver 50 is analyzed for signal strength by signal strength monitoring subsystem 52 which may be a demodulator associated with transceiver 50. Thus, transceiver 50 outputs to microcontroller 54 a signal indicative of any message received by transceiver 50 and also the strength of the signal(s) received by transceiver 50. If the message received by controller 54 is indicative of a theft event, controller 54 signals transponder 12 which is then activated to transmit a signal which can be detected by VTU 22, FIG. 1 of law enforcement vehicle 20.

Controller 54, FIG. 2, however, in accordance with this invention is also programmed to include a proof of life subsystem which periodically forwards a signal on line 56 to transceiver 50 causing transceiver 50 to transmit proof of life message 40, FIG. 1 including the identification code of VLU 10 and the identification code of the network tower previously or currently transmitting the strongest signal to transceiver 50. In one embodiment, controller 54 is a Texas Instrument model MSP 430 with its own EE prom memory for storing these two identification codes. In the same embodiment, controller 54 includes its own internal clock for timing the periodicity of the transmission of the proof of life message. The periodicity of the proof of life signal can be programmable and may occur every day, every week, or even at longer intervals.

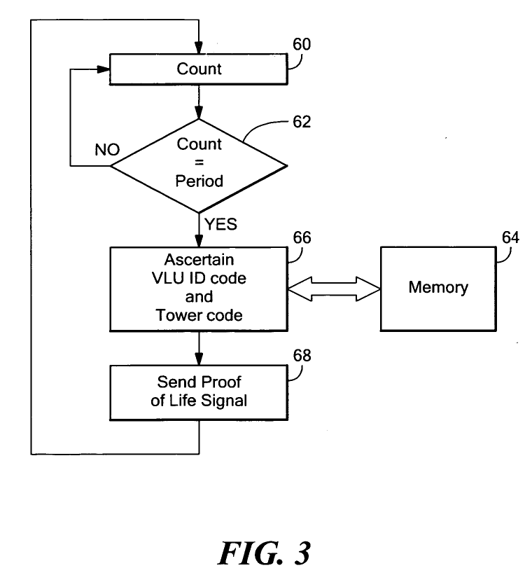

Thus, controller 54, FIG. 2 is programmed to count, step 60, FIG. 3 until the predetermined proof of life period is reached, step 62 and then ascertain the identification code of VLU 10 and the identification code of the network tower with the strongest signal from memory 64, step 66. Controller 54 then packages this data and signals, step 68 transceiver 50, FIG. 2 to transmit the proof of life message via antenna 51 to the network, FIG. 1 whereupon RTU 18 forwards the proof of life message to center 24 to be stored in database 30 for periodic analysis and polling as explained above.

In other examples, the proof of life message is sent to network towers outside of the private network, for example, by equipping VLU 10, FIG. 1 with a cellular telephone transmitter to transmit the proof of life message via a cellular telephone network.

Thus, although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

What is claimed is:

1. A vehicle locating unit with proof of life functionality comprising:
a receiver which receives a signal from a network of communication sources;
a transponder activated when a communication source sends a message to the receiver;
a transmitter for sending signals; and
a proof of life subsystem configured to periodically send a proof of life message via the transmitter.

2. The vehicle locating unit of claim 1 in which the proof of life message includes a unique vehicle locating unit identification code.

3. The vehicle locating unit of claim 2 in which the proof of life message further includes an identification code of a communication source transmitting the strongest signal to the receiver to approximate the position of the vehicle.

4. The vehicle locating unit of claim 3 further including a signal strength determining subsystem for determining the communication source with the strongest signal transmitted to the receiver.

5. The vehicle locating unit of claim 1 in which the transmitter transmits the proof of life message to the network of communication sources.

6. A method of servicing failed vehicle locating units, the method comprising:
configuring the vehicle locating unit to periodically send a message to one or more communication sources;
logging said message in a database; and
servicing said vehicle locating unit if said message is not received.

7. The method of claim 6 in which the message includes a unique vehicle locating unit identification code and an identification code of a communication source transmitting the strongest signal to the vehicle locating unit to approximate the position of the vehicle locating unit.

8. A method of operating a vehicle locating unit, the method comprising:
receiving signals from a network of communication sources;
activating a transponder when a communication source sends a message to vehicle locating unit; and
periodically sending a proof of life message to the communication sources.

9. The method of claim 8 in which the proof of life message includes a unique vehicle locating unit identification code.

10. The method of claim 9 in which the proof of life message further includes an identification code of a communication source transmitting the strongest signal to the receiver to approximate the position of the vehicle.
